(19) United States
(12) Patent Application Publication
(10) Pub. No.: US 2024/0280698 A1
(43) Pub. Date: Aug. 22, 2024

(54) FMCW FREQUENCY-SWEEPING METHOD AND FMCW LIDAR SYSTEM

(71) Applicant: LightIC Technologies HK Limited, Hong Kong (CN)

(72) Inventors: Guomin JIANG, Santa Clara, CA (US); Jinkyu PARK, Santa Clara, CA (US); Hongru HAN, Santa Clara, CA (US); Ziyun KONG, Santa Clara, CA (US); Hasitha JAYATILLEKA, Santa Clara, CA (US); Banghong ZHANG, Santa Clara, CA (US); Tianbo SUN, Santa Clara, CA (US); Jie SUN, Santa Clara, CA (US)

(21) Appl. No.: 18/641,036

(22) Filed: Apr. 19, 2024

Related U.S. Application Data
(63) Continuation of application No. PCT/CN2022/142577, filed on Dec. 28, 2022.

(30) Foreign Application Priority Data
Sep. 7, 2022 (CN) 202211086908.X

(51) Int. Cl. G01S 17/34; G01S 7/4913; G01S 7/58

(52) U.S. Cl. CPC G01S 17/34; G01S 7/58; G01S 7/4913

(57) ABSTRACT

A FMCW frequency-sweeping method and a FMCW LiDAR system. The method includes: obtaining a frequency-sweeping light beam, wherein the frequency-sweeping light beam periodically implements N continuous chirps within a plurality of preset frequency-sweeping measurement periods, N is a positive integer, and N≥2, each chirp includes one frequency-ascending stage having a preset frequency-ascending slope and one frequency-descending stage having a preset frequency-descending slope (S201), and a frequency-sweeping bandwidth of each chirp and a preset frequency-sweeping total bandwidth satisfy following relationship: fₛ=f_{Bw}/N, few is the preset frequency-sweeping total bandwidth, fₛ is the frequency-sweeping bandwidth, a duration of each frequency-ascending stage or each frequency-descending stage and the preset frequency-sweeping measurement period satisfy the following relationship: Tₛ=T₀/2N, wherein T₀ is the preset frequency-sweeping measurement period, and Tₛ is the duration of each frequency-ascending stage or each frequency-descending stage.

### CROSS-REFERENCE TO RELATED APPLICATION

This application is a continuation of a PCT Application No. PCT/CN2022/142577 filed on Dec. 28, 2022, which claims a priority to Chinese Patent Application No. 202211086908.X filed on Sep. 7, 2022, the present disclosures of which are incorporated in their entirety by reference herein.

### TECHNICAL FIELD

The present disclosure relates to the technical field of Light Detection AND Ranging (LiDAR), and in particular, relates to a Frequency-Modulated Continuous Wave (FMCW) frequency-sweeping method and an FMCW LiDAR system.

### BACKGROUND

A LIDAR is a radar system that emits a laser beam to detect a feature quantity such as a position and a speed of a target. An operational principle of the LiDAR is to transmit a detection signal to the target, then compare a received signal reflected from the target with the transmitted signal, and after appropriate processing, related information of the target, such as parameters of a target distance, an orientation, a height, a speed, an attitude, or even a shape of the target may be obtained, so as to detect, track and identify targets such as an aircraft and a missile. Laser radars are now widely deployed in different scenarios including automated vehicles. The LiDAR may actively estimate a distance and a speed of an environmental feature when a scenario is scanned, and generate a point location cloud indicating a three-dimensional shape of an environmental scenario.

### SUMMARY

A Frequency-Modulated Continuous Wave (FMCW) frequency-sweeping method applied to a Light Detection and Ranging system. The method includes:
obtaining a frequency-sweeping light beam, wherein the frequency-sweeping light beam periodically implements N continuous chirps within a plurality of preset frequency-sweeping measurement periods, N is a positive integer, and N≥2, each of the N chirps includes one frequency-ascending stage having a preset frequency-ascending slope and one frequency-descending stage having a preset frequency-descending slope, the one frequency-ascending stage and the one frequency-stage are continuous, and a frequency-sweeping bandwidth of each chirp and a preset frequency-sweeping total bandwidth satisfy following relationship:

fₛ=f_{Bw}/N, few is the preset frequency-sweeping total bandwidth, fₛ is the frequency-sweeping bandwidth, a duration of each frequency-ascending stage or each frequency-descending stage and the preset frequency-sweeping measurement period satisfy the following relationship:

Tₛ=T₀/2N, wherein T₀ is the preset frequency-sweeping measurement period, and Tₛ is the duration of each frequency-ascending stage or each frequency-descending stage.

Optionally, the method further includes
splitting the frequency-sweeping light beam into a transmitted light beam and a local-oscillation light beam, wherein frequency modulation waveforms of the transmitted light beam and the local-oscillation light beam are completely the same;
emitting the transmitted light beam, wherein a reflected light beam is generated after the transmitted light beam encounters an obstacle; and
detecting a beat frequency between the local-oscillation light beam and the reflected light beam to determine a distance and/or a speed of the obstacle.

Optionally, in each preset frequency-sweeping measurement period, frequency-sweeping bandwidth ranges of a first chirp to a N-th chirp are sequentially adjacent, and the frequency-sweeping bandwidth ranges of the first chirp to the N-th chirp are spliced into the preset frequency-sweeping total bandwidth.

Optionally, in each preset frequency-sweeping measurement period, a lower limit of a frequency-sweeping bandwidth range of an i-th chirp is equal to an upper limit of a frequency-sweeping bandwidth range of a (i−1)-th chirp, and an upper limit of a frequency-sweeping bandwidth range of the i-th chirp is equal to a lower limit of a frequency-sweeping bandwidth range of a (i+1)-th chirp, wherein i is a positive integer, and 2≤i≤N−1

Optionally, a lower limit of a frequency-sweeping bandwidth range of the first chirp is equal to a lower limit of the preset frequency-sweeping total bandwidth, and an upper limit of a frequency-sweeping range of the N-th chirp is equal to an upper limit of the preset frequency-sweeping total bandwidth.

Optionally, detecting the beat frequency between the local-oscillation light beam and the reflected light beam to determine the distance and/or the speed of the obstacle includes:
performing frequency-mixing on the reflected light beam and the local-oscillation light beam to obtain a frequency-mixing signal;
obtaining frequency-mixing signals corresponding to any continuously adjacent N chirps and corresponding to one measurement point, to increase a measurement point density; and
performing recombination on the frequency-mixing signals corresponding to the any continuously adjacent N chirps to obtain a recombined frequency-mixing signal, so that the recombined frequency-mixing signal corresponds to a preset chirp with a preset frequency-sweeping measurement period and a preset frequency-sweeping total bandwidth, and the preset chirp includes one frequency-ascending stage and one frequency-descending stage;
calculating a beat frequency according to the recombined frequency-mixing signal to determine a distance and/or a speed of the obstacle.

Optionally, performing recombination on the frequency-mixing signals corresponding to the any continuously adjacent N chirps to obtain the recombined frequency-mixing signal includes:
performing time translation and recombination on the frequency-mixing signals corresponding to frequency-ascending stages of the N continuously adjacent chirps to obtain a recombined frequency-ascending frequency-mixing signal, wherein the recombined frequency-ascending frequency-mixing signal corresponds to a frequency-ascending stage of the preset chirp; and
performing time translation and recombination on the frequency-mixing signals corresponding to frequency-descending stages of the N continuously adjacent chirps to obtain a recombined frequency-descending frequency-mixing signal, wherein the recombined frequency-descending frequency-mixing signal corresponds to a frequency-descending stage of the preset chirp.

Optionally, the distance R of the obstacle is determined by a following formula:

$$R = \frac{{C}_{0}}{8} \frac{{T}_{0}}{{f}_{BW}} ( {f}_{b 1} + {f}_{b 2} )$$

wherein T₀ is a preset frequency-sweeping measurement period, few is the preset frequency-sweeping total bandwidth, f_{b1} is a beam frequency of the frequency-ascending stage, f_{b2} is a beat frequency of the frequency-descending stage, and C₀ is the light speed.

Optionally, the speed V of the obstacle satisfies following relationship:

$$v = - \frac{{C}_{0}}{4} \frac{1}{{f}_{0}} ( {f}_{b 1} - {f}_{b 2} )$$

wherein C₀ is the light speed, f_{b1} is a beam frequency of the frequency-ascending stage, f_{b2} is a beat frequency of the frequency-descending stage, and f₀ is a frequency of an unmodulated light beam.

A Frequency-Modulated Continuous Wave (FMCW) Light Detection and Ranging (LiDAR) system is provided. The system includes:
a laser light source configured to generate a frequency-sweeping light beam, wherein the frequency-sweeping light beam periodically implements N continuous chirps within a plurality of preset frequency-sweeping measurement periods, N is a positive integer, and N≥2, each of the N chirps includes one frequency-ascending stage having a preset frequency-ascending slope and one frequency-descending stage having a preset frequency-descending slope, the one frequency-ascending stage and the one frequency-stage are continuous, and a frequency-sweeping bandwidth of each chirp and a preset frequency-sweeping total bandwidth satisfy following relationship;
fₛ=f_{Bw}/N, f_{Bw} is the preset frequency-sweeping total bandwidth, fₛ is the frequency-sweeping bandwidth, a duration of each frequency-ascending stage or each frequency-descending stage and the preset frequency-sweeping measurement period satisfy the following relationship;
Tₛ=T₀/2N, wherein T₀ is the preset frequency-sweeping measurement period, and Tₛ is the duration of each frequency-ascending stage or each frequency-descending stage.

Optionally, the system further includes:
a beam splitter configured to split the frequency-sweeping light beam into an transmitted light beam and a local-oscillation light beam, wherein frequency modulation waveforms of the transmitted light beam and the local-oscillation light beam are completely the same;
a light transmitter configured to emit the transmitted light beam, wherein a reflected light beam is generated after the transmitted light beam encounters an obstacle;
a light receiver configured to receive the reflected light beam; and
a detector configured to detect a beat frequency between the local-oscillation light beam and the reflected light beam to determine a distance of the obstacle.

Optionally, the detector includes:
a frequency-mixing unit configured to perform frequency-mixing on the reflected light beam and the local-oscillation light beam to obtain a frequency-mixing signal;
a frequency-mixing signal interception unit, configured to obtain frequency-mixing signals corresponding to any continuously adjacent N chirps as one measurement point to increase a measurement point density;
a recombination unit, configured to perform recombination on the frequency-mixing signals corresponding to the any continuously adjacent N chirps to obtain a recombined frequency-mixing signal, so that the recombined frequency-mixing signal corresponds to a preset chirp with a preset frequency-sweeping measurement period and a preset frequency-sweeping total bandwidth, the preset chirp includes one frequency-ascending stage and one frequency-descending stage; and a calculation unit, configured to calculate a beat frequency according to the recombined frequency-mixing signal to determine a distance and/or a speed of the obstacle.

Compared with the related art, the above solutions of the embodiments of the present disclosure has at least the following beneficial effects:
the FMCW method of the present disclosure can be used to recombine frequency-mixing signals of multiple chirps by periodically implementing the multiple continuous chirps in multiple preset frequency-sweeping measurement periods periodically, and improve the measurement point density while ensuring the integral duration of the frequency-mixing signal, thereby improving the resolution of the FMCW LiDAR system.

### BRIEF DESCRIPTION OF THE DRAWINGS

The accompanying drawings, which are incorporated in and constitute a part of this description, illustrate embodiments of the present disclosure and, together with the description, serve to explain principles of the present disclosure. Obviously, the accompanying drawings in the following description are merely some embodiments of the present disclosure, and for a person of ordinary skill in the art, other drawings may also be obtained according to these accompanying drawings without creative efforts.

FIG. 1 is a waveform diagram of a transmitted light beam and a received light beam in a conventional FWCW frequency-sweeping method in the related art.

FIG. 2 is a flowchart of an FMCW frequency-sweeping method according to some embodiments of the present disclosure.

FIG. 3 is a waveform diagram of a transmitted light beam and a received light beam in an FMCW frequency-sweeping method using micro-chirps according to some embodiments of the present disclosure.

FIG. 4 is a specific flowchart of step S204 in FIG. 2.

FIG. 5 is a schematic diagram of rearranged frequency-mixing signals according to some embodiments of the present disclosure.

FIG. 6 is a schematic structural diagram of an FMCW LiDAR system according to some embodiments of the present disclosure.

### DETAILED DESCRIPTION

In order to make objectives, technical solutions, and advantages of the present disclosure clearer, the present disclosure will be further described in detail below with reference to the accompanying drawings, and obviously, the described embodiments are merely some, rather than all, of the embodiments of the present disclosure. All other embodiments obtained by a person of ordinary skill in the art based on the embodiments of the present disclosure without creative efforts shall fall within the protection scope of the present disclosure.

The terminology used in the embodiments of the present disclosure is for the purpose of describing particular embodiments only and is not intended to be limiting of the present disclosure. Singular forms “a”, “an” and “the” are also intended to include plural forms, unless the context clearly indicates other meanings, and “a plurality of” generally includes at least two.

It should be understood that the term “and/or” used herein is merely an association relationship describing associated objects, indicating that three relationships may exist, for example, A and/or B may indicate that A exists alone, A and B exist simultaneously, and B exists alone. In addition, the character “/” in this specification generally indicates an “or” relationship between the associated objects.

It should be understood that although the terms first, second, third, etc. may be used in the embodiments of the present disclosure, these terms should not be limited to these terms. These terms are only used to distinguish objects. For example, without departing from the scope of the embodiments of the present disclosure, the first may also be referred to as the second, and similarly, the second may also be referred to as the first.

It should also be noted that the terms “include”, “include” or any other variations thereof are intended to cover a non-exclusive inclusion, so that a commodity or a device including a series of elements not only includes those elements, but also includes other elements not explicitly listed, or further includes elements inherent to such a commodity or device. Without more restrictions, if an element after the phrase “including” is recited, it is not excluded presence of additional identical elements in the product or device that includes the element.

In the related art, an existing LiDAR is mainly based on one of the following two technical routes: Time of Flight (ToF) and Frequency-Modulated Continuous Wave (FMCW).

A distance measurement principle of TOF is that a distance is measured and calculated by multiplying time of flight between a target object and a laser radar with a speed of light by using a light pulse, and a TOF laser radar adopts a pulse amplitude modulation technology. Unlike the TOF, the FMCW mainly enable the reflected light beam to interfere with a local light beam by sending and receiving a continuous laser beam, measures frequency difference between the transmitted light beam and the received light beam by using a frequency-mixing technology, and then calculates the distance of a target by using the frequency difference. Briefly, TOF uses time to measure the distance, while FMCW uses a frequency to measure the distance. Compared with the TOF, FMCW has the following advantages: a light beam of the TOF is easily interfered by ambient light, and anti-interference capability of a light beam of the FMCW is very strong; a signal-to-noise ratio of the TOF is too low, while a signal-to-noise ratio of the FMCW is very high, and a data amount of the TOF in a speed dimension is low, whereas the FMCW can obtain data of each pixel point in the speed dimension

A laser radar using a technical route of FMCW has a good technical advantage, but the following problems exist in practical applications: for a conventional FMCW LiDAR, a distance resolution is inversely proportional to a frequency-modulation bandwidth. In order to improve the distance resolution, a large frequency-modulation bandwidth is usually required, for example, a frequency-modulation bandwidth of 3 GHz or more, for example, a distance resolution of 1 cm requires a frequency-modulation bandwidth of 15 GHz. For a direct-modulation light source, such as a narrow linewidth DFB (Distributed Feedback Laser) laser device or an external cavity laser device, it is difficult to generate a wide linear frequency-sweeping in a short time; for an external modulation laser device, it is difficult to generate a large-range continuous frequency modulation radio frequency signal, and at the same time, the system bandwidth requirement is high, the system complexity is high, and the cost is high.

When the FMCW LiDAR system performs measurement, a measurement point density of the FMCW LiDAR system is related to a ranging period of the FMCW LiDAR system, the smaller the ranging period, the larger the measurement point density, and the higher the resolution of the FMCW LiDAR system. The ranging period of the FMCW LiDAR system should not be too small, and is generally not less than 40 μm, and if the ranging period is less than 40 μm, then an integral duration of the frequency-mixing signal corresponding to the received reflected light beam is not long enough, and may not be recognized by a detector, causing that the FMCW LiDAR system cannot work normally.

The present disclosure provides an FMCW frequency-sweeping method, applied to a FMCW LiDAR system, and the FMCW frequency-sweeping method includes: acquiring a frequency-sweeping light beam; dividing the frequency-sweeping light beam into a transmitted light beam and a local-oscillation light beam, wherein a frequency modulation waveform of the transmitted light beam and the frequency modulation waveform of the local-oscillation light beam are completely the same; and emitting the transmitted light beam so that the transmitted light beam is reflected to generate a reflected light beam after encountering an obstacle; and detecting a beat frequency between the local-oscillation light beam and the reflected light beam to determine a distance and/or a speed of the obstacle, wherein N continuous periodically chirps exist in the frequency-sweeping light beam within a plurality of preset frequency-sweeping measurement periods, N is a positive integer, and N≥2, each chirp includes one frequency-ascending stage having a preset frequency-ascending slope and one frequency-descending stage having a preset frequency-descending slope, the frequency-ascending stage and the frequency-descending stage are continuous. The frequency-sweeping bandwidth of each chirp and a preset frequency-sweeping total bandwidth satisfy the following relationship: fₛ=f_{Bw}/N, few is the preset frequency-sweeping total bandwidth, fₛ is the frequency-sweeping bandwidth of each chirp, and the duration of each frequency-ascending stage or the duration of each frequency-descending stage satisfies the following relationship with a preset frequency-sweeping measurement period: Tₛ=T₀/2N, where T₀ is the preset frequency-sweeping measurement period, and Tₛ is the duration of each frequency-ascending stage or each frequency-descending stage.

According to the FMCW frequency-sweeping method provided by the present disclosure, multiple continuous chirps are periodically implemented within a plurality of preset frequency-sweeping measurement periods, and may be used to recombine a plurality of chirped frequency-mixing signals, and improve the measurement point density while ensuring an integral duration of the frequency-mixing signal, thereby improving the resolution of the FMCW LiDAR system.

Optional embodiments of the present disclosure will be described in detail below with reference to the accompanying drawings.

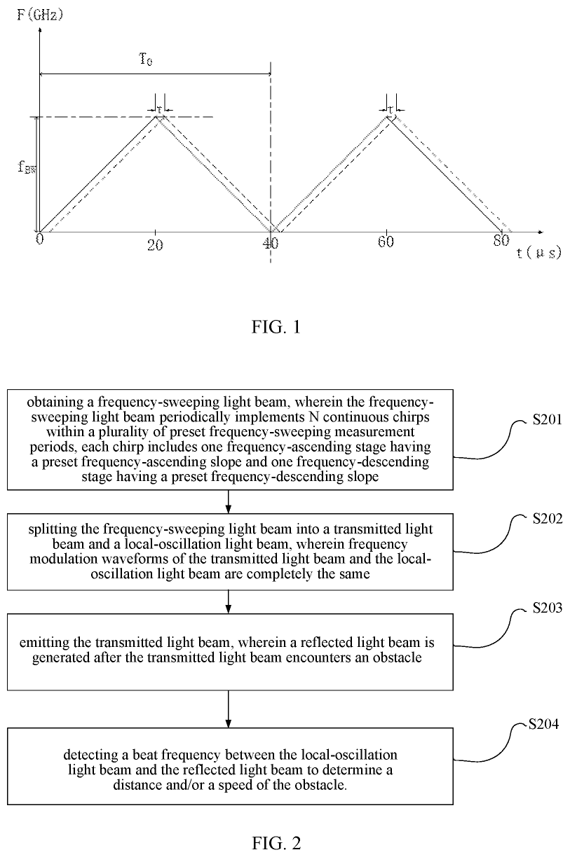

FIG. 1 is a waveform diagram of a transmitted light beam and a received light beam in a conventional FWCW frequency-sweeping method in the related art. As shown in FIG. 1, in the related art, a frequency-sweeping optical signal of the transmitted light beam emitted by the laser radar is represented by a solid line, the solid line reflects the curve of the frequency of the transmitted light beam changing with time, the frequency-sweeping optical signal is, for example, a periodic triangular wave signal, a reflected optical signal of the reflected light beam received by the laser radar is represented by a dashed line, the dashed line reflects the curve of the frequency of the received reflected light beam changing over time, and the reflected optical signal is also, for example, a periodic triangular wave signal, and there is a delay between the reflected optical signal and the frequency-sweeping optical signal.

Only two frequency-sweeping measurement periods are shown in FIG. 1, and in each frequency-sweeping measurement period, the frequency-sweeping optical signal includes one frequency-ascending stage and one frequency-descending stage, and correspondingly, the corresponding reflected optical signal also includes one frequency-ascending stage and one frequency-descending stage.

As shown in FIG. 1, the abscissa represents the time, the unit thereof is μs, the ordinate represents the frequency, the unit thereof is GHz, the frequency of the transmitted light beam increases from, for example, 0 to 4 GHz with the increase of time, and then decreases from 4 GHz to 0, and periodically changes in this way, and correspondingly, the frequency of the received reflected light beam also increases from 0 to 4 GHz with the increase of time, and then decreases from 4 GHz to 0, and also periodically changes in this way.

For example, the frequency-sweeping measurement period T₀ of the laser radar is 40 μs, for example. Each frequency-sweeping measurement period of the laser radar corresponds to one measurement point, and the measurement points described herein have the following meanings: when the laser radar performs scanning and detection, the transmitted light beam is incident onto a certain position of the obstacle to generate the reflected light beam, and the position of the obstacle is marked as a measurement point. The distance between each measurement point and the laser radar and the movement speed of each measurement point may be determined based on the frequency-sweeping optical signal and the reflected optical signal corresponding thereto in each frequency-sweeping measurement period. The laser radar may form a point cloud image based on measurement information of the plurality of measurement points, and the resolution of the point cloud image is closely related to the density of the measurement points.

As described above, the density of the measurement points is negatively correlated with the frequency-sweeping measurement period of the FMCW LiDAR system, while the frequency-sweeping measurement period of the FMCW LiDAR system cannot be too small, otherwise, the integral duration of the frequency-mixing signal corresponding to the received reflected light beam is insufficient, which may not be accurately received and identified by the detector, causing that the FMCW LiDAR system cannot work normally.

FIG. 2 is a flowchart of an FMCW frequency-sweeping method according to some embodiments of the present disclosure. As shown in FIG. 2, some embodiments of the present disclosure provide an FMCW frequency-sweeping method applied to a laser radar, which may be the FMCW LiDAR system 100 described in the foregoing embodiment, and the FMCW frequency-sweeping method includes the following steps S201 to S204.

S201: obtaining a frequency-sweeping light beam.

The frequency-sweeping light beam is generated by a laser light source, and the laser light source can be directly modulated by chirp signals. For example, a driving signal for controlling the laser light source may be input to the laser light source at an intensity varying with time, so that the laser light source generates and outputs a frequency-sweeping light beam, that is, a light beam whose frequency changes in a predetermined range. In some embodiments, the laser light source may also include a modulator that receives a modulated signal. The modulator may be configured to modulate a light beam based on the modulated signal to generate and output the frequency-sweeping light beam, i.e. a light beam having a frequency that varies in a predetermined range.

In the FMCW frequency-sweeping method, a plurality of continuous chirps is periodically implemented to the frequency-sweeping light beam in a plurality of preset frequency-sweeping measurement periods, and each chirp includes one continuous frequency-ascending stage having a preset frequency-ascending slope and one frequency-descending stage having a preset frequency-descending slope.

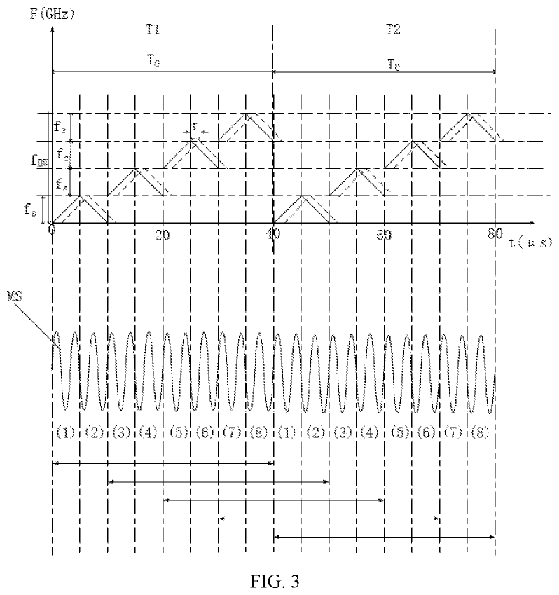

FIG. 3 is a waveform diagram of a transmitted light beam and a received light beam in an FMCW frequency-sweeping method using micro-chirps provided by some embodiments of the present disclosure. As shown in FIG. 3, the abscissa represents the time, the unit thereof is μs, the ordinate represents the frequency, the unit thereof is GHz, the frequency-sweeping optical signal of the transmitted light beam emitted by the laser radar is represented by a solid line, and the solid line reflects the curve of the frequency of the transmitted light beam changing with time. The frequency-sweeping light beam includes for example a plurality of preset frequency-sweeping measurement periods T₀ configured periodically and continuously, and in order to facilitate comparison with the frequency-sweeping optical signal in the related art, the preset frequency-sweeping measurement period T₀ in FIG. 3 and the frequency-sweeping measurement period in FIG. 1 are set to be the same, and the preset frequency-sweeping total bandwidth few in FIG. 3 and the frequency-sweeping bandwidth in FIG. 1 are set to be the same, and the preset frequency-ascending slope in FIG. 3 and the frequency-ascending slope in FIG. 1 are set to be the same, and the preset frequency-descending slope in FIG. 3 and the frequency-descending slope in FIG. 1 are set to be the same. In FIG. 3, each frequency-sweeping measurement period T₀ includes a plurality of chirps, for example, N chirps, N is a positive integer, and N≥2, and each chirp includes one frequency-ascending stage having a preset frequency-ascending slope and one frequency-descending stage having a preset frequency-descending slope, and the frequency-ascending stage and the frequency-descending stage are continuous.

The frequency-sweeping bandwidth of each chirp and the preset frequency-sweeping total bandwidth satisfy the following relationship:

$${f}_{S} = {f}_{B W} / N$$

where f_{BW} is the preset frequency-sweeping total bandwidth, fₛ is the frequency-sweeping bandwidth.

The duration of each frequency-ascending stage or each frequency-descending stage and the preset frequency-sweeping measurement period satisfy the following relationship:

$${T}_{S} = {T}_{0} / 2 n$$

where T₀ is the preset frequency-sweeping measurement period, and Tₛ is the duration of each frequency-ascending stage or each frequency-descending stage.

In FIG. 3, each period of the triangular wave of the transmitted light beam using a large-range frequency-sweeping bandwidth as shown in FIG. 1 is divided into a plurality of chirps, each of which has a small-range frequency-sweeping bandwidth. In some embodiments, for example, each period 40 us of the triangular wave having a frequency-sweeping bandwidth 4 GHz is divided into 4 chirps, each of the 4 chips has a small-range frequency-sweeping bandwidth that is, N is 4. Each chirp includes one frequency-ascending stage and one frequency-ascending stage which are continuous, and the frequency-ascending stage and the frequency-ascending stage each has the same duration, for example, the frequency-ascending slope of the frequency-ascending stage in FIG. 3 is the same as the frequency-ascending slope of the frequency-ascending phase in FIG. 1, and the frequency-ascending slope of the frequency-ascending phase in FIG. 1 may be used as the preset frequency-ascending slope. In FIG. 3, the frequency-descending slope of the frequency-descending stage is the same as the frequency-descending slope of the frequency-descending phase in FIG. 1, and the frequency-descending slope of the frequency-descending phase in FIG. 1 may be used as a preset frequency-descending slope. The preset frequency-ascending slope and the preset frequency-descending slope may be the same or different.

In the FMCW frequency-sweeping method provided in the foregoing embodiment, the frequency-sweeping bandwidth of each chirp is significantly smaller than the preset frequency-sweeping total bandwidth, and the large-range frequency-sweeping is replaced by the small-range frequency-sweeping. A frequency-sweeping bandwidth requirement is reduced, so that the FMCW laser radar is simple, a system power consumption is low, and a cost is reduced.

In some embodiments, in each preset frequency-sweeping measurement period, sweep bandwidth ranges of a first chirp to a n-th chirp are sequentially adjacent, and the sweep bandwidth ranges of the first chirp to the n-th chirp are spliced to form the preset frequency-sweeping total bandwidth.

In some embodiments, in each preset frequency-sweeping measurement period, a lower limit of a frequency-sweeping bandwidth range of an i-th chirp is equal to an upper limit of a frequency-sweeping bandwidth range of a (i−1)-th chirp, and an upper limit of a frequency-sweeping bandwidth range of the i-th chirp is equal to a lower limit of a frequency-sweeping bandwidth range of a (i+1)th chirp, where i is a positive integer, 2≤i≤N−1, a lower limit of a frequency-sweeping bandwidth range of the first chirp is equal to a lower limit of the preset frequency-sweeping total bandwidth, and an upper limit of a frequency-sweeping bandwidth range of the N-th chirp is equal to an upper limit of the preset frequency-sweeping total bandwidth.

As shown in FIG. 3, taking N=4 as an example, a frequency-sweeping bandwidth range of the first chirp is 0 GHz to 1 GHz, a frequency-sweeping bandwidth range of the second chirp is 1 GHz to 2 GHz, a frequency-sweeping bandwidth range of the third chirp is 2 GHz to 3 GHz, and a frequency-sweeping bandwidth range of the fourth chirp is 3 GHz to 4 GHZ, and the frequency-sweeping bandwidth ranges of the four chirps are sequentially adjacent to each other, and can be spliced to form the preset frequency-sweeping total bandwidth 0 GHz to 4 GHz.

In other embodiments, in each preset frequency-sweeping measurement period, the sweep bandwidth ranges of the N chirps may be the same. For example, when N=4, the sweep bandwidth ranges from the first chirp to the fourth chirp are 0 GHz to 1 GHz, 1 GHz to 2 GHz, 2 GHz to 3 GHZ, and 3 GHz to 4 GHz.

S202: Splitting the frequency-sweeping light beam into a transmitted light beam and a local-oscillation light beam, where the frequency-modulation waveforms of the transmitted light beam and the local-oscillation light beam are completely the same.

The received frequency-sweeping light beam is split into the transmitted light beam and the local-oscillation light beam by using a beam splitter, and the transmitted light beam and the local-oscillation light beam have the same frequency at any time instant, that is, the frequency modulation waveforms of the transmitted light beam and the local-oscillation light beam are completely the same.

S203: emitting the transmitted light beam so that the transmitted light beam is reflected to generate the reflected light beam after encountering an obstacle.

A light transmitter/receiver is used to emit the transmitted light beam at a predetermined angle, and the light transmitter/receiver is used to receive the reflected light beam reflected by the obstacle after the transmitted light beam encounters the obstacle.

S204: detecting a beat frequency between the local-oscillation light beam and the reflected light beam to determine a distance and/or a speed of the obstacle.

Specifically, the local-oscillation light beam is mixed with the received reflected light beam, and the frequency-mixing signal generated after the mixing is recombined to increase the density of the measurement points, and beat frequency calculation is performed based on the recombined frequency-mixing signal of the measurement points to determine the distance and/or speed of the obstacle.

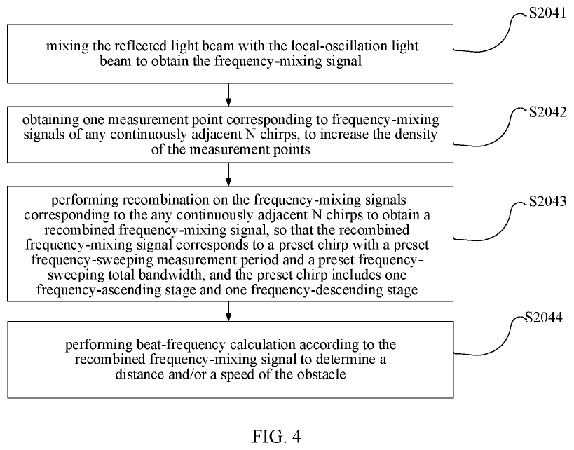

FIG. 4 is a specific flowchart of the step S204 in FIG. 2, as shown in FIG. 4, the step S204 specifically includes steps S2041 to S2044.

S2041: mixing the reflected light beam with the local-oscillation light beam to obtain the frequency-mixing signal.

The local-oscillation light beam is mixed with the received reflected light beam through a frequency-mixing device to obtain the frequency-mixing signal. The frequency-mixing device is a coupler or the like, and the frequency-mixing signal is, for example, a coherent signal generated by interference between the local-oscillation light beam and the corresponding reflected light beam.

The mixing signal MS obtained through mixing is schematically shown in FIG. 3, and in each chirp, since the frequency-sweeping optical signal of the transmitted light beam is continuous, the generated frequency-mixing signal MS is also continuous, but the frequency-sweeping optical signals of the transmitted light beams between adjacent chirps and the generated frequency-mixing signals MS between adjacent chirps are not discontinuous. In a preset frequency-sweeping measurement period TO, the N chirps respectively correspond to different frequency-mixing signal segments, and the frequency-ascending stage and the frequency-descending stage of each chirp also correspond to different frequency-mixing signal segments.

For example, as shown in FIG. 3, four chirps are implemented in each preset frequency-sweeping measurement period T₀ (for example, 40 μs), and in each preset frequency-sweeping measurement period, the frequency-mixing signal segment corresponding to the frequency-ascending stage of the first chirp is marked as (1), the frequency-mixing signal segment corresponding to the frequency-descending stage of the first chirp is marked as (2), the frequency-mixing signal segment corresponding to the frequency-ascending stage of the second chirp is marked as (3), the frequency-mixing signal segment corresponding to the frequency-descending stage of the second chirp is marked as (4), the frequency-mixing signal segment corresponding to the frequency-ascending stage of the third chirp is marked as (5), the frequency-mixing signal segment corresponding to the frequency-descending stage of the third chirp is marked as (6), the frequency-mixing signal segment corresponding to the frequency-ascending stage of the fourth chirp is marked as (7), the frequency-mixing signal segment corresponding to the frequency-descending stage of the fourth chirp is marked as (8).

S2042: obtaining one measurement point corresponding to frequency-mixing signals of any continuously adjacent N chirps, to increase the density of the measurement points.

Taking N=4 as an example, the frequency-mixing signal segments corresponding to the four chirps in the first preset frequency-sweeping measurement period T1 are first obtained, that is, (1) to (8) in the first preset frequency-sweeping measurement period T1. Data of the eight frequency-mixing signal segments corresponds to one measurement point, and calculation of one measurement point may be performed based on the data of the eight frequency-mixing signal segments.

Then, frequency-mixing signal segments corresponding to the last three chirps in the first preset frequency-sweeping measurement period T1 and the first chirp in the second preset frequency-sweeping measurement period T2 are obtained, i.e., (3) to (8) in the first preset frequency-sweeping measurement period T1 and (1) and (2) in the second preset frequency-sweeping measurement period T2, and the data of the eight frequency-mixing signal segments corresponds to one measurement point, and one measurement point calculation may be performed based on the data of the eight frequency-mixing signal segments.

Next, frequency-mixing signal segments corresponding to the last two chirps in the first preset frequency-sweeping measurement period T1 and top two chirps in the second preset frequency-sweeping measurement period T2 are obtained, i.e., (5) to (8) in the first preset frequency-sweeping measurement period T1 and (1) to (4) in the second preset frequency-sweeping measurement period T2, and the data of the eight frequency-mixing signal segments corresponds to one measurement point, and one measurement point calculation may be performed based on the data of the eight frequency-mixing signal segments.

Further, frequency-mixing signal segments corresponding to the fourth chirp in the first preset frequency-sweeping measurement period T1 and top three chirps in the second preset frequency-sweeping measurement period T2 are obtained, i.e., (7) and (8) in the first preset frequency-sweeping measurement period T1 and (1) to (6) in the second preset frequency-sweeping measurement period T2, and the data of the eight frequency-mixing signal segments corresponds to one measurement point, and one measurement point calculation may be performed based on the data of the eight frequency-mixing signal segments.

Still further, frequency-mixing signal segments corresponding to the four chirps in the second preset frequency-sweeping measurement period T2 are obtained, that is, (1) to (8) in the second preset frequency-sweeping measurement period T2. The data of the eight frequency-mixing signal segments corresponds to one measurement point, and one measurement point calculation may be performed based on the data of the eight frequency-mixing signal segments.

Similarly, each preset frequency-sweeping measurement period T₀ may correspond to four measurement points, and compared with only one measurement point corresponding to each preset frequency-sweeping measurement period T₀ in the related art, this embodiment may improve the density of the measurement points while ensuring the integral duration of the frequency-mixing signal, for example, the density of the measurement points may be increased by N times compared with the related art, thereby improving the resolution of the FMCW LiDAR system.

S2043: performing recombination on the frequency-mixing signals corresponding to the any continuously adjacent N chirps to obtain a recombined frequency-mixing signal, so that the recombined frequency-mixing signal corresponds to a preset chirp with a preset frequency-sweeping measurement period and a preset frequency-sweeping total bandwidth, and the preset chirp includes one frequency-ascending stage and one frequency-descending stage.

Before the measurement point calculation is performed by using the frequency-mixing signal segments corresponding to any continuously adjacent N chirps, the frequency-mixing signal segments need to be recombined first, where the recombined frequency-mixing signal corresponds to a preset chirp with a preset frequency-sweeping measurement period and a preset frequency-sweeping total bandwidth, and the preset chirp includes one frequency-ascending stage and one frequency-descending stage, so that the phase difference between segments of the obtained recombined frequency-mixing signal is minimum, and the complexity of signal processing is reduced.

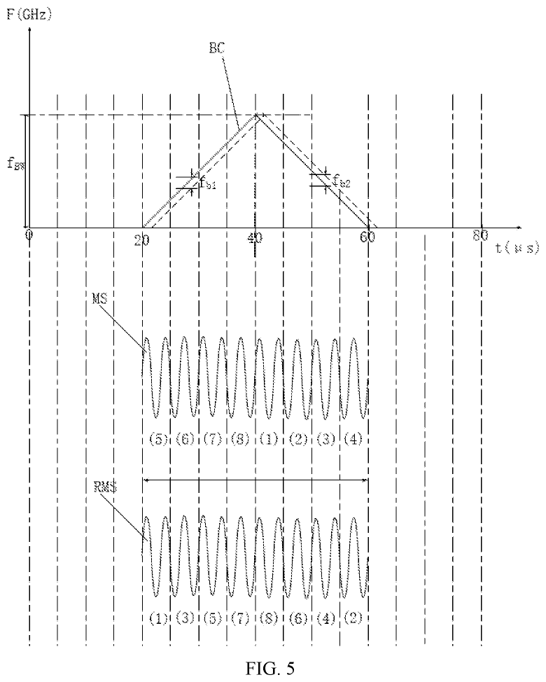

FIG. 5 is a schematic diagram of recombination of frequency-mixing signals provided by some embodiments of the present disclosure, and FIG. 5 is explained by taking the recombination of frequency-mixing signal segments of the last two chirps in the first preset frequency-sweeping measurement period T1 and the frequency-mixing signal segments of the top two chirps of the second preset frequency-sweeping measurement period T2 in FIG. 3 as an example, that is, (5) to (8) in the first preset frequency-sweeping measurement period T1 and (1) to (4) in the second preset frequency-sweeping measurement period T2 are recombined.

As shown in FIGS. 5, (5) to (8) in the first preset frequency-sweeping measurement period T1 and (1) to (4) in the second preset frequency-sweeping measurement period T2 obtained in sequence are recombined according to a sequence of (1), (3), (5), (7), (8), (6), (4) and (2), so that the recombined frequency-mixing signal RMS corresponds to a preset chirp BC with a preset frequency-sweeping measurement period T₀ and a preset frequency-sweeping total bandwidth f_{Bw}, the preset chirp BC includes one frequency-ascending band and one frequency-descending band, and the recombined frequency-mixing signal RMS is continuous.

Step S2043 may specifically include the following steps S20431 to S20432.

S20431: performing time translation and recombination on the frequency-mixing signals corresponding to the frequency-ascending stages of the continuously adjacent N chirps to obtain a recombined frequency-ascending frequency-mixing signal, where the recombined frequency-ascending frequency-mixing signal corresponds to the frequency-ascending stage of the preset chirp.

With reference to FIG. 3 and FIG. 5, the frequency-sweeping optical signals of the frequency-ascending stages corresponding to the frequency-mixing signal segments in the first preset frequency-sweeping measurement period T1 and the second preset frequency-sweeping measurement period T2 are as follows:

### Frequency-Sweeping Optical Signals

$$\begin{matrix}sin ( π ( \frac{{f}_{s}}{{T}_{s}} t ) t ) & 0 \leq t \leq {T}_{s} & ( 1 ) \\ sin ( π ( \frac{{f}_{s}}{{T}_{s}} ( t - {T}_{s} ) ) ( t - {T}_{s} ) ) & 2 {T}_{s} \leq t \leq 3 {T}_{s} & ( 3 ) \\ sin ( π ( \frac{{f}_{s}}{{T}_{s}} ( t - 2 {T}_{s} ) ) ( t - 2 {T}_{s} ) ) & 4 {T}_{s} \leq t \leq 5 {T}_{s} & ( 5 ) \\ sin ( π ( \frac{{f}_{s}}{{T}_{s}} ( t - 3 {T}_{s} ) ) ( t - 3 {T}_{s} ) ) & 6 {T}_{s} \leq t \leq 7 {T}_{s} & ( 7 )\end{matrix} \} \qquad T 1$$

$$\begin{matrix}sin ( π ( \frac{{f}_{s}}{{T}_{s}} ( t - 8 {T}_{s} ) ) ( t - 8 {T}_{s} ) ) & 8 {T}_{s} \leq t \leq 9 {T}_{s} & ( 1 ) \\ sin ( π ( \frac{{f}_{s}}{{T}_{s}} ( t - 9 {T}_{s} ) ) ( t - 9 {T}_{s} ) ) & 10 {T}_{s} \leq t \leq 11 {T}_{s} & ( 3 ) \\ sin ( π ( \frac{{f}_{s}}{{T}_{s}} ( t - 10 {T}_{s} ) ) ( t - 10 {T}_{s} ) ) & 12 {T}_{s} \leq t \leq 13 {T}_{s} & ( 5 ) \\ sin ( π ( \frac{{f}_{s}}{{T}_{s}} ( t - 11 {T}_{s} ) ) ( t - 11 {T}_{s} ) ) & 14 {T}_{s} \leq {t157T}_{s} & ( 7 )\end{matrix} \} \qquad T 2$$

where fₛ is the frequency-sweeping bandwidth, and Tₛ is the duration of each frequency-ascending stage.

The reflected optical signals of the frequency-ascending stages corresponding to the segments in the first preset frequency-sweeping measurement period T1 and the second preset frequency-sweeping measurement period T2 are as follows:

### Reflected Optical Signals

$$\begin{matrix}sin ( π ( \frac{{f}_{s}}{{T}_{s}} ( t - τ ) ) ( t - τ ) ) & 0 \leq t \leq {T}_{s} & ( 1 ) \\ sin ( π ( \frac{{f}_{s}}{{T}_{s}} ( t - {T}_{s} - τ ) ) ( t - {T}_{s} - τ ) ) & 2 {T}_{s} \leq t \leq 3 {T}_{s} & ( 3 ) \\ sin ( π ( \frac{{f}_{s}}{{T}_{s}} ( t - 2 {T}_{s} - τ ) ) ( t - 2 {T}_{s} - τ ) ) & 4 {T}_{s} \leq t \leq 5 {T}_{s} & ( 5 ) \\ sin ( π ( \frac{{f}_{s}}{{T}_{s}} ( t - 3 {T}_{s} - τ ) ) ( t - 3 {T}_{s} - τ ) ) & 6 {T}_{s} \leq t \leq 7 {T}_{s} & ( 7 )\end{matrix} \} \qquad T 1$$

$$\begin{matrix}sin ( π ( \frac{{f}_{s}}{{T}_{s}} ( t - 8 {T}_{s} - τ ) ) ( t - 8 {T}_{s} - τ ) ) & 8 {T}_{s} \leq t \leq 9 {T}_{s} & ( 1 ) \\ sin ( π ( \frac{{f}_{s}}{{T}_{s}} ( t - 9 {T}_{s} - τ ) ) ( t - 9 {T}_{s} - τ ) ) & 10 {T}_{s} \leq t \leq 11 {T}_{s} & ( 3 ) \\ sin ( π ( \frac{{f}_{s}}{{T}_{s}} ( t - 10 {T}_{s} - τ ) ) ( t - 10 {T}_{s} - τ ) ) & 12 {T}_{s} \leq t \leq 13 {T}_{s} & ( 5 ) \\ sin ( π ( \frac{{f}_{s}}{{T}_{s}} ( t - 11 {T}_{s} - τ ) ) ( t - 11 {T}_{s} - τ ) ) & 14 {T}_{s} \leq {t157T}_{s} & ( 7 )\end{matrix} \} \qquad T 2$$

where fₛ is the frequency-sweeping bandwidth, Tₛ is the duration of each frequency-ascending stage, and τ is the delay of the reflected optical signal relative to the frequency-sweeping optical signal.

Next, frequency-mixing processing is performed on the frequency-sweeping optical signal and the reflected optical signal, for example, convolution processing is used.

For example, the frequency-sweeping optical signal and the reflected optical signal in (1) in the first preset frequency-sweeping period are processed as follows: for ease of calculation,

$$a = \frac{{f}_{s}}{{T}_{s}}$$

convolution calculation is performed on the frequency-sweeping optical signal and the reflected optical signal:

$$sin ( π {at}^{2} ) \times sin ( π {a ( t - τ )}^{2} ) = \frac{1}{2} ( cos ( π a ( 2 t τ - {τ}^{2} ) ) - cos ( π a ( 2 {t}^{2} - 2 t τ + {τ}^{2} ) ) ) \approx \frac{1}{2} cos ( π a ( 2 t τ - {τ}^{2} ) )$$

The high-frequency second term which is negligible are ignored in the above calculation.

Convolution calculations are performed on the frequency-sweeping optical signal and the reflected optical signal in (1), (3), (5) and (7) in the first preset frequency-sweeping measurement period and (1), (3), (5) and (7) in the second preset frequency-sweeping measurement period, specifically as follows:

frequency mixing signals

Next, with reference to FIG. 5, the frequency-mixing signals corresponding to the selected (5) and (7) in the first preset frequency-sweeping measurement period T1 and (1) and (3) in the second preset frequency-sweeping measurement period T2 are recombined. Specifically, in a case that the waveform and the amplitude of the frequency-mixing signal corresponding to each segment are kept unchanged, time translation of the frequency-mixing signals is performed and the translated frequency-mixing signals are combined. Specifically:

$$\begin{matrix}\frac{1}{2} cos ( π a ( 2 t τ - {τ}^{2} ) ) & 0 \leq t \leq {T}_{s} & ( 1 ) \\ \frac{1}{2} cos ( π a ( 2 t τ - {τ}^{2} ) ) & {T}_{s} \leq t \leq 2 {T}_{s} & ( 3 )\end{matrix} \} \qquad T 2$$

$$\begin{matrix}\frac{1}{2} cos ( π a ( 2 t τ - {τ}^{2} ) ) & 2 {T}_{s} \leq t \leq 3 {T}_{s} & ( 1 ) \\ \frac{1}{2} cos ( π a ( 2 t τ - {τ}^{2} ) ) & 3 {T}_{s} \leq t \leq 4 {T}_{s} & ( 3 )\end{matrix} \} \qquad T 1$$

Frequency-mixing signals corresponding to (1) in the second preset sweep measurement period T2 is translated by 8 Tₛ, the frequency-mixing signals corresponding to (3) in the second preset sweep measurement period T2 is translated by 9 Tₛ, the frequency-mixing signals corresponding to (5) in the first preset sweep measurement period T1 is translated by 2 Tₛ, and the frequency-mixing signals corresponding to (7) in the second preset sweep measurement period T2 is translated by 3 Tₛ.

In this case, the frequency-mixing signals in (1) and (3) in the second preset frequency-sweeping measurement period T2 and the corresponding frequency-mixing signals in (5) and (7) in the first preset frequency-sweeping measurement period T1 are sequentially arranged, so that phases of the frequency-mixing signals may be continuously set, thereby obtaining the recombined frequency-ascending frequency-mixing signal after recombination. The recombined frequency-ascending frequency-mixing signal corresponds to the frequency-ascending stage of the preset chirp BC in FIG. 5.

S20422: perform time translation and recombination on the frequency-mixing signals corresponding to the frequency-descending stages of the any continuously adjacent N chirps, to obtain a recombined frequency-descending frequency-mixing signal, where the recombined frequency-ascending frequency-mixing signal corresponds to the frequency-descending stage of the preset chirp.

Similar to the frequency-ascending stage, time translation and recombination are performed on the frequency-mixing signals corresponding to the frequency-descending stages of any continuously adjacent N chirps. For example, time translation and recombination are performed on the frequency-mixing signals corresponding to (6) and (8) in the first preset frequency-sweeping measurement period T1 and (2) and (4) the second preset frequency-sweeping measurement period T2, and the formula thereof is not repeated again.

The frequency-mixing signals in (8) and (6) in the second preset frequency-sweeping measurement period T2 and the frequency-mixing signals in (4) and (2) in the first preset frequency-sweeping measurement period T1 are sequentially arranged, so that the phases of the frequency-mixing signals may be continuously set, thereby obtaining the recombined frequency-descending frequency-mixing signal after the recombination. The recombined frequency-descending frequency-mixing signal corresponds to the frequency-descending stage of the preset chirp BC in FIG. 5.

S2044: performing beat-frequency calculation according to the recombined frequency-mixing signal to determine a distance and/or a speed of the obstacle.

For any measurement point, the distance R of the obstacle is determined by the following formula:

$$R = \frac{{C}_{0}}{8} \frac{{T}_{0}}{{f}_{BW}} ( {f}_{b 1} + {f}_{b 2} )$$

where T₀ is a preset frequency-sweeping measurement period, few is the preset frequency-sweeping total bandwidth, f_{b1} is the beat frequency of the frequency-ascending stage, f_{b2} is the beat frequency of the frequency-descending stage, and C₀ is the light speed.

The velocity V of the obstacle satisfies the following relationship:

$$v = - \frac{{C}_{0}}{4} \frac{1}{{f}_{0}} ( {f}_{b 1} - {f}_{b 2} )$$

where C₀ is the light speed, f_{b1} is the beat frequency of the frequency-ascending stage, f_{b2} is the beat frequency of the frequency-descending stage, and f₀ is the frequency of an unmodulated light beam.

In the FMCW frequency-sweeping method in this embodiment of the present disclosure, multiple continuous chirps are periodically implemented within a plurality of preset frequency-sweeping measurement periods, recombination of frequency-mixing signals of the multiple chirps may be performed, and the measurement point density is improved while ensuring the integral duration of the frequency-mixing signals, thereby improving the resolution of the FMCW LiDAR system.

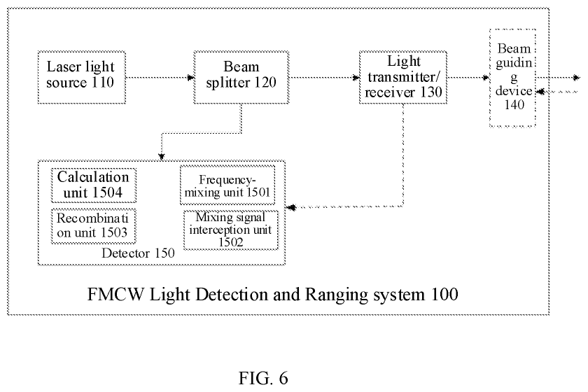

Some embodiments of the present disclosure further provide an FMCW LiDAR system, and FIG. 6 is a schematic structural diagram of an FMCW LiDAR system according to some embodiments of the present disclosure, as shown in FIG. 6, the FMCW LiDAR system 100 includes a laser light source 110, a beam splitter 120, a light transmitter, a light receiver, and a detector 150

The FMCW LiDAR system 100 is configured to generate and receive one or more light beams. In some examples, at least some components of the FMCW LiDAR system 100 may be integrated on a semiconductor chip to reduce the size of the FMCW LiDAR system 100. The components of the FMCW LiDAR system 100 may be implemented in the form of semiconductor modules on a chip.

The laser light source 110 may be integrated on a semiconductor chip, and may be directly modulated by using a chirp driver. That is, a driving signal for controlling the laser light source 110 may be input to the laser light source 110 at an intensity changing with time, so that the laser light source 110 generates and outputs a frequency-sweeping light beam, that is, a light beam whose frequency changes in a predetermined range. In some embodiments, the laser light source 100 may further include a modulator that receives the modulated signal. The modulator may be configured to modulate the light beam based on the modulated signal to generate and output a frequency-sweeping light beam, i.e. a light beam having a frequency that varies in a predetermined range. In some embodiments, the laser light source 110 may further include an external laser light source, the external laser light source is connected to the semiconductor chip through an optical path (for example, an optical fiber), the frequency of a laser beam output by the laser light source 110 when the laser beam is not modulated is substantially constant, and is referred to as the frequency of the unmodulated light beam, for example, 100-300 THz. The laser light source 110 may output the frequency-sweeping light beam after modulation is performed, and the frequency range of the frequency-sweeping light beam is related to the frequency of the unmodulated light beam.

The beam splitter 120 is, for example, integrated on the semiconductor chip, and is configured to receive the frequency-sweeping light beam output from the laser light source 110, and further split the frequency-sweeping light beam into two parts, i.e., the transmitted light beam and the local-oscillation light beam. The transmitted light beam may be transmitted to the light transmitter 130, the local-oscillation light beam may be transmitted to the detector 150, the transmitted light beam and the local-oscillation light beam have the same frequency at any time instant, i.e., the frequency modulation waveforms of the transmitted light beam and the local-oscillation light beam are exactly the same.

The light transmitter is, for example, integrated on a semiconductor chip, and may be configured to emit the transmitted light beam at a predetermined angle. When the transmitted light beam encounters an obstacle during propagation, the reflected light beam may be generated on the surface of the obstacle. The reflected light beam may be received by the light receiver. The light receiver may be integrated, for example, on a semiconductor chip, and the received reflected light beam may be transmitted to the detector 150

In some embodiments, the light emitter and the light receiver may be integrated into one component, for example, the light transceiver/receiver 130 shown in FIG. 6, so as to realize coaxial transmission and reception, for example, the transmitted light beam and the reflected light beam which are coaxial may be distinguished or separated by means of a polarization-splitting device or a three-port circulator.

The detector 150 is, for example, integrated on a semiconductor chip and is configured to detect a beat frequency between the local-oscillation light beam and the reflected light beam to determine a speed and a distance of the obstacle, and the beat frequency refers to a frequency difference between the local-oscillation light beam and the reflected light beam.

In some embodiments, the FMCW LiDAR system 100 may further include a processor, which may also be integrated on the semiconductor chip, the processor may calculate the distance of the obstacle according to the beat frequency detected by the detector 150, that is, the distance between the obstacle and the FMCW LiDAR system 100, and when the obstacle is a moving object, the processor may further calculate the speed of the obstacle according to the beat frequency detected by the detector 150.

In some embodiments, the FMCW LiDAR system 100 further includes a beam guiding device 140 configured to adjust an emergent direction of the transmitted light beam emitted from the light emitter over time to achieve beam-scanning. The beam guiding device is, for example, an optical phased array (OPA) that can direct the direction of a beam by dynamically controlling optical properties of a surface on the microscopic scale. In other embodiments, the beam guiding device may further include a grating, a mirror galvanometer, a polygon mirror, a MEMS mirror, or a combination of an optical phased array (OPA) and the foregoing devices.

The frequency-sweeping light beam periodically implements continuous N chirps within a plurality of preset frequency-sweeping measurement periods, each chirp includes one frequency-ascending stage and one frequency-descending stage that are continuous.

The bandwidth of each chirp and the preset frequency-sweeping total bandwidth satisfy the following relationship:

$${f}_{S} = {f}_{B W} / N$$

where few is the preset frequency-sweeping total bandwidth, fₛ is the frequency-sweeping bandwidth.

The duration of each frequency-ascending stage and the duration of each frequency-descending stage and the preset frequency-sweeping measurement period satisfy the following relationship:

$${T}_{S} = {T}_{0} / 2 N$$

where T₀ is the preset frequency-sweeping measurement period, and Tₛ is the duration of each frequency-ascending stage or each frequency-descending stage.

In some embodiments, as shown in FIG. 6, the detector includes a frequency-mixing unit 1501, a frequency-mixing signal intercepting unit 1502, a recombination unit 1503, and a calculation unit 1504.

The frequency-mixing unit 1501 performs frequency-mixing on the reflected light beam and the local-oscillation light beam to obtain the frequency-mixing signal MS. The frequency-mixing signal interception unit 1502 obtains frequency-mixing signals corresponding to any continuously adjacent N chirps as one measurement point to increase the density of the measurement points. The recombination unit 1503 performs recombination on the frequency-mixing signals corresponding to the N consecutively chirps to obtain a recombined frequency-mixing signal, so that the recombined frequency-mixing signal corresponds to a preset chirp with a preset frequency-sweeping measurement period and a preset frequency-sweeping total bandwidth, and the preset chirp includes one frequency-ascending stage and one frequency-descending stage. The calculation unit 1504 calculates the beat frequency according to the recombined frequency-mixing signal to determine the distance and/or speed of the obstacle.

Various parts in the specification are described in a parallel and progressively, each part focuses on differences from other parts, and the same or similar portions between the parts can be referred to each other.

Based on the above description of the disclosed embodiments, the features described in the embodiments of the present specification can be replaced or combined with each other, so that those skilled in the art can implement or use the present application. Various modifications to these embodiments will be readily apparent to those skilled in the art, and the generic principles defined herein may be implemented in other embodiments without departing from the spirit or scope of the present application. Thus, the present disclosure will not be limited to the embodiments shown herein, but is to be accorded to the widest scope consistent with the principles and novel features disclosed herein.

Finally, it should be noted that the embodiments in the present specification are described by way of examples, each embodiment focuses on the differences from other embodiments, and the same or similar portions between the various embodiments can be obtained by referring to each other. For the system or the device disclosed in the embodiments, since it corresponds to the method disclosed in the embodiments, the description of the system or the device is relatively simple, and the relevant parts can be obtained by referring to the description of the method.

The above embodiments are only used to describe the technical solutions of the present disclosure, and should not be used to limit the present disclosure. Although the present disclosure has been described in detail with reference to the foregoing embodiments, those of ordinary skill in the art should understand that they can still modify the technical solutions described in the foregoing embodiments or make equivalent replacements to some of the technical features thereof; and these modifications or replacements do not depart from the spirit and scope of the technical solutions of the embodiments of the present disclosure.

What is claimed is:

1. A Frequency-Modulated Continuous Wave (FMCW) frequency-sweeping method applied to a laser Light Detection and Ranging system, the method comprising:
obtaining a frequency-sweeping light beam, wherein the frequency-sweeping light beam periodically implements N continuous chirps within a plurality of preset frequency-sweeping measurement periods, N is a positive integer, and N≥2, each of the N chirps comprises one frequency-ascending stage having a preset frequency-ascending slope and one frequency-descending stage having a preset frequency-descending slope, the one frequency-ascending stage and the one frequency-stage are continuous, and a frequency-sweeping bandwidth of each chirp and a preset frequency-sweeping total bandwidth satisfy following relationship;
fₛ=f_{Bw}/N, few is the preset frequency-sweeping total bandwidth, fₛ is the frequency-sweeping bandwidth, a duration of each frequency-ascending stage or each frequency-descending stage and the preset frequency-sweeping measurement period satisfy the following relationship;
Tₛ=T₀/2N, wherein T₀ is the preset frequency-sweeping measurement period, and Tₛ is the duration of each frequency-ascending stage or each frequency-descending stage.

2. The FMCW frequency-sweeping method according to claim 1, further comprising:
splitting the frequency-sweeping light beam into a transmitted light beam and a local-oscillation light beam, wherein frequency modulation waveforms of the transmitted light beam and the local-oscillation light beam are completely the same;
emitting the transmitted light beam, wherein a reflected light beam is generated after the transmitted light beam encounters an obstacle; and
detecting a beat frequency between the local-oscillation light beam and the reflected light beam to determine a distance and/or a speed of the obstacle.

3. The FMCW frequency-sweeping method according to claim 2, wherein in each preset frequency-sweeping measurement period, frequency-sweeping bandwidth ranges of a first chirp to a N-th chirp are sequentially adjacent, and the frequency-sweeping bandwidth ranges of the first chirp to the N-th chirp are spliced into the preset frequency-sweeping total bandwidth.

4. The FMCW frequency-sweeping method according to claim 3, wherein in each preset frequency-sweeping measurement period, a lower limit of a frequency-sweeping bandwidth range of an i-th chirp is equal to an upper limit of a frequency-sweeping bandwidth range of a (i−1)-th chirp, and an upper limit of a frequency-sweeping bandwidth range of the i-th chirp is equal to a lower limit of a frequency-sweeping bandwidth range of a (i+1)-th chirp, wherein i is a positive integer, and 2≤i≤N−1.

5. The FMCW frequency-sweeping method according to claim 4, wherein a lower limit of a frequency-sweeping bandwidth range of the first chirp is equal to a lower limit of the preset frequency-sweeping total bandwidth, and an upper limit of a frequency-sweeping range of the N-th chirp is equal to an upper limit of the preset frequency-sweeping total bandwidth.

6. The FMCW frequency-sweeping method according to claim 2, wherein detecting the beat frequency between the local-oscillation light beam and the reflected light beam to determine the distance and/or the speed of the obstacle comprises:
performing frequency-mixing on the reflected light beam and the local-oscillation light beam to obtain a frequency-mixing signal;
obtaining frequency-mixing signals corresponding to any continuously adjacent N chirps and corresponding to one measurement point, to increase a measurement point density; and
performing recombination on the frequency-mixing signals corresponding to the any continuously adjacent N chirps to obtain a recombined frequency-mixing signal, so that the recombined frequency-mixing signal corresponds to a preset chirp with a preset frequency-sweeping measurement period and a preset frequency-sweeping total bandwidth, and the preset chirp comprises one frequency-ascending stage and one frequency-descending stage;
calculating a beat frequency according to the recombined frequency-mixing signal to determine a distance and/or a speed of the obstacle.

7. The FMCW frequency-sweeping method according to claim 6, wherein performing recombination on the frequency-mixing signals corresponding to the any continuously adjacent N chirps to obtain the recombined frequency-mixing signal comprises:
performing time translation and recombination on the frequency-mixing signals corresponding to frequency-ascending stages of the N continuously adjacent chirps to obtain a recombined frequency-ascending frequency-mixing signal, wherein the recombined frequency-ascending frequency-mixing signal corresponds to a frequency-ascending stage of the preset chirp; and
performing time translation and recombination on the frequency-mixing signals corresponding to frequency-descending stages of the N continuously adjacent chirps to obtain a recombined frequency-descending frequency-mixing signal, wherein the recombined frequency-descending frequency-mixing signal corresponds to a frequency-descending stage of the preset chirp.

8. The FMCW frequency-sweeping method according to claim 6, wherein the distance R of the obstacle is determined by a following formula:
$$R = \frac{{C}_{0}}{8} \frac{{T}_{0}}{{f}_{BW}} ( {f}_{b 1} + {f}_{b 2} )$$
wherein T₀ is a preset frequency-sweeping measurement period, few is the preset frequency-sweeping total bandwidth, f_{b1} is a beam frequency of the frequency-ascending stage, f_{b2} is a beat frequency of the frequency-descending stage, and C₀ is the light speed.

9. The FMCW frequency-sweeping method according to claim 6, wherein the speed V of the obstacle satisfies following relationship:
$$v = - \frac{{C}_{0}}{4} \frac{1}{{f}_{0}} ( {f}_{b 1} - {f}_{b 2} )$$
wherein C₀ is the light speed, f_{b1} is a beam frequency of the frequency-ascending stage, f_{b2} is a beat frequency of the frequency-descending stage, and f₀ is a frequency of an unmodulated light beam.

10. A Frequency-Modulated Continuous Wave (FMCW) Light Detection and Ranging (LiDAR) system, comprising:
a laser light source configured to generate a frequency-sweeping light beam, wherein the frequency-sweeping light beam periodically implements N continuous chirps within a plurality of preset frequency-sweeping measurement periods, N is a positive integer, and N≥2, each of the N chirps comprises one frequency-ascending stage having a preset frequency-ascending slope and one frequency-descending stage having a preset frequency-descending slope, the one frequency-ascending stage and the one frequency-stage are continuous, and a frequency-sweeping bandwidth of each chirp and a preset frequency-sweeping total bandwidth satisfy following relationship;
fₛ=f_{Bw}/N, few is the preset frequency-sweeping total bandwidth, fₛ is the frequency-sweeping bandwidth, a duration of each frequency-ascending stage or each frequency-descending stage and the preset frequency-sweeping measurement period satisfy the following relationship;
Tₛ=T₀/2N, wherein T₀ is the preset frequency-sweeping measurement period, and Tₛ is the duration of each frequency-ascending stage or each frequency-descending stage.

11. The FMCW LiDAR system according to claim 10, further comprising:
a beam splitter configured to split the frequency-sweeping light beam into an transmitted light beam and a local-oscillation light beam, wherein frequency modulation waveforms of the transmitted light beam and the local-oscillation light beam are completely the same;
a light transmitter configured to emit the transmitted light beam, wherein a reflected light beam is generated after the transmitted light beam encounters an obstacle;
a light receiver configured to receive the reflected light beam; and
a detector configured to detect a beat frequency between the local-oscillation light beam and the reflected light beam to determine a distance of the obstacle.

12. The FMCW LiDAR system according to claim 11, wherein the detector comprises:
a frequency-mixing unit configured to perform frequency-mixing on the reflected light beam and the local-oscillation light beam to obtain a frequency-mixing signal;
a frequency-mixing signal interception unit, configured to obtain frequency-mixing signals corresponding to any continuously adjacent N chirps as one measurement point to increase a measurement point density;
a recombination unit, configured to perform recombination on the frequency-mixing signals corresponding to the any continuously adjacent N chirps to obtain a recombined frequency-mixing signal, so that the recombined frequency-mixing signal corresponds to a preset chirp with a preset frequency-sweeping measurement period and a preset frequency-sweeping total bandwidth, the preset chirp comprises one frequency-ascending stage and one frequency-descending stage; and
a calculation unit, configured to calculate a beat frequency according to the recombined frequency-mixing signal to determine a distance and/or a speed of the obstacle.
